(19) United States
(12) Patent Application Publication
(10) Pub. No.: US 2006/0084406 A1
(43) Pub. Date: Apr. 20, 2006

(54) Systems and methods for increasing bandwidth of wireless communications

(76) Inventors: James A. Strachan, Temecula, CA (US); Randy A. Silks, Angeles Oak, CA (US); Jurell Silks, Angeles Oaks, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/253,090

(22) Filed: Oct. 17, 2005

Related U.S. Application Data
(60) Provisional application No. 60/620,132, filed on Oct. 19, 2004.

(51) Int. Cl. H04B 1/18; H04B 1/16

(52) U.S. Cl. 455/334; 455/280

(57) ABSTRACT

An improved radio transmitter encodes at least one data bit on each cycle of a carrier signal. The data is encoded on the carrier signal using phase modulation. Because at least one data bit is encoded on each cycle of the carrier signal, a carrier signal having a frequency (f) carries data at a rate of (f) bits per second. Thus, a 900 MHz carrier signal may carry a 900 Mbps data signal. In this embodiment, a radio receiver does not include a mixer, a local oscillator, and other traditional mixer components, but instead includes one or more digital signal processors that are able to decode the data modulated on the carrier signal at the carrier frequency. In one embodiment, each waveform of a received signal is analyzed and converted to a bit electronically without converting the received signal to one or more lower frequency signals.

### CROSS-REFERENCE TO RELATED APPLICATIONS

This application claims priority under 35 U.S.C. §119(e) to U.S. Provisional Application Ser. No. 60/620,132, filed on Oct. 19, 2004, which is hereby expressly incorporated by reference in its entirety.

### BACKGROUND OF THE INVENTION

1. Field of the Invention

This invention relates to the field of wireless computer networking technology. More specifically, the invention relates to systems and methods for allowing wireless broadband (e.g., greater than 11 Mbps) digital communications with near infinite scalable bandwidth, and theoretical performance well into the multi-gigabit per second range.

2. Description of the Related Art

Radio receivers typically receive modulated radio frequency (RF) signals and generate a lower intermediate frequency (IF) signal by stripping off the received carrier signal (or smashing it) with a waveform generated from an attached local oscillator (LO). This occurs within the Mixer circuitry in the receiver design. More than one Mixer may be employed in a radio design, resulting in a 1^{st} IF, 2^{nd} IF, and so forth.

One of the problems associated with the intermediate frequency and mixer methodology derived from the Marconi era (1926) is a division of the frequency that results in a data transmission rate less than the carrier, thus, reducing available bandwidth in wireless digital communications. For example, if a 50 Mbps signal is to be transmitted using current RF communication technology, a carrier signal of a much higher frequency, such as 5 GHz, must be transmitted. Thus, one limitation of current communication systems is limited bandwidth.

The current IEEE and industry standards for wireless data communication offer bandwidth that is a mere fraction of the throughput provided through a contemporary wired network. For example, Fast Ethernet technology offers 100 megabits per second (Mbps) and Gigabit Ethernet offers up to 1000 Mbps throughput in half duplex. The next generation of cabled Ethernet standard is 10 Gigabit Ethernet (IEEE 802.3ae),

Current IEEE wireless bandwidth falls well short of these bandwidth levels. For example, Wireless 802.11b offers up to 11 Mbps and Wireless 802.16 (WiMAX) offers up to 72 Mbps, and the anticipated 802.11n standard promises up to 320 Mbps. Thus, there is currently a great disparity between the bandwidth available using wired and wireless communications. Systems and methods that provide increased wireless bandwidth capabilities are desired.

Current RF receivers use mixers to frequency divide the received data signal. For example, an RF signal may be sent to a first mixer, which is coupled to a local oscillator (LO). The mixer modifies the signal, resulting in an intermediate frequency (IF) which is then converted to conventional bits (1's and 0's) in the receiver's Discriminator. For example, the LO may generate a signal that is combined with the received signal in the mixer in order to strip away the carrier waveform. The resulting signal is an Intermediate Frequency (IF) that is a fraction of the original carrier. This process of mixing the received signal with an oscillator signal may be performed repeatedly, each time reducing the frequency of the received RF signal. In an exemplary embodiment, a mixer produces an Intermediate Frequency (f_{RF}) that is ⅔ the original signal. If this signal is then sent to a second mixer, the resultant signal will have an even lower frequency, such as ⅓ of f_{RF}. Thus, in this example, a division of a division of the original signal is being transmitted. If a 5 GHz frequency will result in maximum throughput of 54 Mbps. In contemporary RF data communications designs, the intelligence is incorporated within the modulation, and the mixer is used to strip off the intelligence.

One reason for frequency conversion is to allow amplification of the received signal at a frequency other than the RF, or the audio, frequency. A receiver may require as much as 140 decibels (dB) of gain. It might not be possible to put more than 40 dB of gain into the RF section without risking instability and potential oscillations. Likewise the gain of the audio section might be limited to 60 dB because of parasitic feedback paths, and microphonics. The additional gain needed for a sensitive receiver is normally achieved in an intermediate frequency (IF) section of the receiver.

Some communication systems increase bandwidth by either applying complex modulation through multiplexing techniques to increase the amount of intelligence received on a given frequency; and/or by increasing the frequency of the transmission thereby increasing the amount of intelligence received over a given period of time. Other systems employ port aggregation (or Trunking) to two or more wireless channels to aggregate (or combine) the channels bandwidth into a single logical link. These solutions, however, do not address the problem of frequency division in the mixer. Thus, the bandwidth of current RF data signals is inefficiently used and limits the speed at which wireless communication may occur.

In order to obtain radio data communications into the Gigabit range, a unique and innovative solution must be developed to eliminate the Mixer and subsequent frequency division from the radio system, yet still be capable of converting and re-converting digital I/O to RF, and back.

### SUMMARY OF THE INVENTION

In one embodiment, an improved radio transmitter encodes at least one data bit on each cycle of a carrier signal. For example, the data may be encoded on the carrier signal using phase modulation, such as Quad Phase Shift Keying (QPSK). Because at least one data bit is encoded on each cycle of the carrier signal, a carrier signal having a frequency (f) carriers data at a rate of (f) bits per second. Thus, a 900 MHz carrier signal may carry a 900 Mbps data signal. In this embodiment, a radio receiver does not include a mixer, a local oscillator, and other traditional mixer components, but instead includes one or more digital signal processors that are able to decode the data modulated on the carrier signal at the carrier frequency. Because no frequency division is necessary, the bit stream throughput for a given carrier frequency may be increased. Thus, the systems and methods described herein do not “smash and divide” as do Marconian conventional radios, but instead “receive and analyze.” In one embodiment, each waveform of a received signal is analyzed and converted to a bit electronically without converting the received signal to one or more lower IF signals. For example, using the systems and methods described herein, a 5 GHz RF signal is theoretically able to obtain throughput of at least 5 Gbps, rather than the 54 Mbps now available on IEEE 802.11g standards based equipment.

The following references provide background information on wireless networking systems and technology. Each of these reference is hereby incorporated by reference in their entireties: Next-Generation Network Architectures: Servicing and Supporting the Wireless LAN Environment, IDC #24449, April 2001; Unwiring the Network: Worldwide Wireless LAN Market Forecast update, 2000-2005, IDC #24391, April 2001; Infonetics Research, Inc., “User Plans for High Performance LANs 2000, April 2000; Wireless LANs, Joel Wood, Ohio State; Gigabit Ethernet Technology and Solutions, Intel, 2001.

In one embodiment, a no-conversion radio for decoding data encoded on individual waveforms of a received radio frequency signal, wherein the radio frequency signal comprises at least one bit of data encoded on each waveform, comprises a receiver for receiving a radio signal, a filter for attenuating portions of the radio signal outside a predetermined frequency range, and one or more digital signal processors for selecting the predetermined frequency of the radio signal and decoding data encoded on each waveform of the radio frequency signal so that data is decoded at a rate of about one bit per waveform, wherein the one or more digital signal processors operate on the radio signal at the predetermined frequency.

In another embodiment, a method of receiving radio signals containing modulated data on a carrier signal having a predetermined frequency, wherein each waveform of the carrier signal is modulated to encode at least one bit of data, comprises receiving a radio signal, attenuating portions of the radio signal outside the predetermined frequency range, and selecting the predetermined frequency of the radio signal, amplifying the predetermined frequency of the radio signal, and decoding at least one bit of data encoded on each waveform of the amplified radio signal.

In another embodiment, a method of detecting a predetermined frequency of radio signal comprises storing a bit pattern in a memory, receiving a radio signal comprising multiple radio frequencies including a signal having a predetermined frequency intended for decoding, decoding data encoded on a the received radio signal, comparing the decoded data against the bit pattern stored in memory, and determining that the signal having the predetermined frequency is being received when the decoded data matches the bit pattern stored in memory.

In another embodiment, a wireless data transmitter configured to transmit data encoded as phase modulations in an RF carrier signal comprises a data input port, a processor coupled to the data input port, the processor receiving a digital data stream comprising a plurality of data bits via the data input port and encoding the data stream onto a carrier signal having a predetermined frequency, wherein each waveform of the carrier signal is modulated to encode at least one data bit of the data stream, and a transmission module for transmitting the encoded carrier signal at a predetermined frequency.

In another embodiment, a wireless digital data device configured to receive data at a rate of more than one gigabit per second, the device comprises an antenna assembly configured to receive a radio frequency data signal, a low noise amplifier electrically coupled to the antenna for amplifying the data signal, a notch filter coupled to the low noise amplifier for passing only a predetermined frequency range of the radio frequency data signal, referred to as a filtered data signal, and one or more Digital Signal Processors (DSPs) each configured to detect a single frequency of the filtered data signal and extrapolate data from each waveform of the filtered data signal without mixing the data signal with another signal, wherein the one or more DSPs output a binary data stream at a rate of at least one bit per waveform of the received radio frequency data signal.

### BRIEF DESCRIPTION OF THE DRAWINGS

FIG. 1 is a block diagram of an exemplary wireless communication system.

FIG. 2A illustrates a complete cycle of an exemplary waveform, including 360 degrees of phase.

FIG. 2B illustrates exemplary waves that are in phase quadrature.

FIG. 2C illustrates a digital signal and exemplary portions of an FSK signal that may be used to represent the digital signal.

FIG. 3 is a block diagram illustrating the transmitting module and receiving module of FIG. 1, and an exemplary portion of a transmitted wireless communication.

FIG. 4 is a flowchart diagram of an exemplary receiving module coupled to receive a digital representation of a received wireless communication.

FIG. 5 is a block diagram of an exemplary transceiver that includes both a receiving module and a transmitting module.

FIG. 6 is a flowchart illustrating an exemplary process of transmitting and receiving digital data.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The term “module,” as used herein, means, but is not limited to, a software or hardware component, such as a field programmable gate array (FPGA) or an application specific integrated circuit (ASIC), which performs certain tasks. A module may advantageously be configured to reside on an addressable storage medium and configured to execute on one or more processes. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

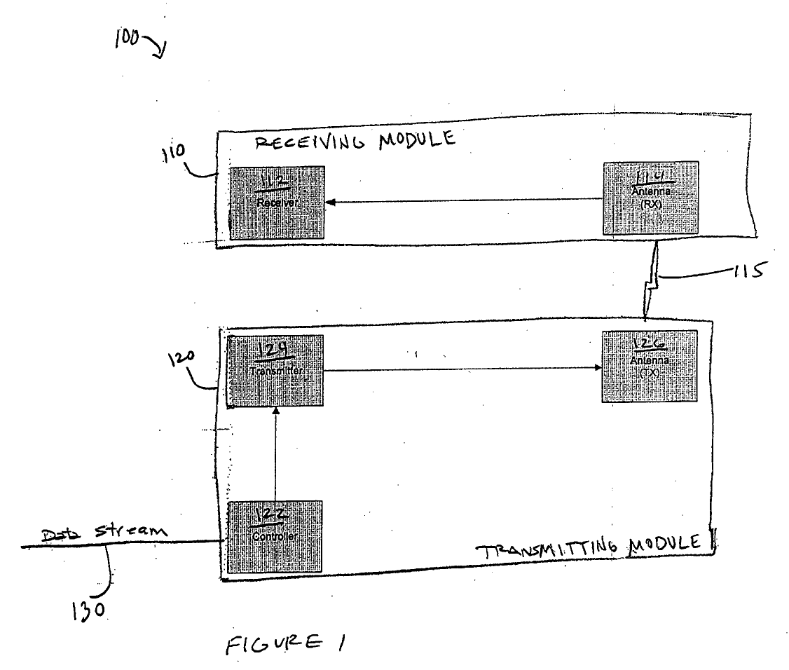

FIG. 1 is a block diagram of an exemplary wireless communication system. In the embodiment of FIG. 1, a transmitting module 120 communicates with a receiving module 110 via a wireless communication link 115. In one embodiment, the wireless communication link 115 comprises a RF signal having at least one data bit encoded on each waveform, such as by phase modulating the RF signal.

In the embodiment of FIG. 1, the transmitting module 120 comprises a controller 122, a transmitter 124, and an antenna 126. In one embodiment, the controller 122 is coupled to receive an input data stream 130 from a network device, or any other computing device. In one embodiment, the controller 122 generates a signal at a desired transmission frequency, such as 900 MHz or 2.8 GHz, for example. The controller 122 comprises processing circuitry, such as a Field Programmable Gate Array (FPGA), that is programmed to modulate each waveform of the generated signal with a bit of the data stream 130. The controller 122 may be configured to modulate the data stream on the generated signal using any form of modulation, such as Quad Phase Shift Keying (QPSK), for example. Once the signal has been modulated with data from the data stream 130, the modulated signal is sent to the transmitter 124. In one embodiment, the transmitter filters and amplifies the modulated signal and then transmits the signal to the antenna 126. The antenna 126 comprises any suitable antenna for transmitting the wireless communication 115.

As noted above, the data stream 130 may be modulated by any other suitable modulation methods. Modulation, in general, is the addition of information to an electronic or optical signal carrier. Modulation can be applied to direct current (mainly by turning it on and off), to alternating current, and to optical signals. For many radio communication signals, the carrier is alternating current (AC) in a given range of frequencies. Common modulation methods include, for example, Amplitude modulation (AM), in which the voltage applied to the carrier is varied over time; Frequency modulation (FM), in which the frequency of the carrier waveform is varied in small but meaningful amounts; and Phase modulation (PM), in which the natural flow of the alternating current waveform is delayed temporarily. More complex forms of modulation include Phase Shift Keying (PSK) and Quadrature Amplitude Modulation (QAM). In an advantageous embodiment, continuous wave (CW) modulation, also referred to as on/off keying is used to modulate the carrier wave. Using CW modulation, the transmitted signal may be capable of traveling greater distances than other modulation schemes and through interference that attenuates others. Any of these modulation methods may be suitable for use in the systems and methods described herein.

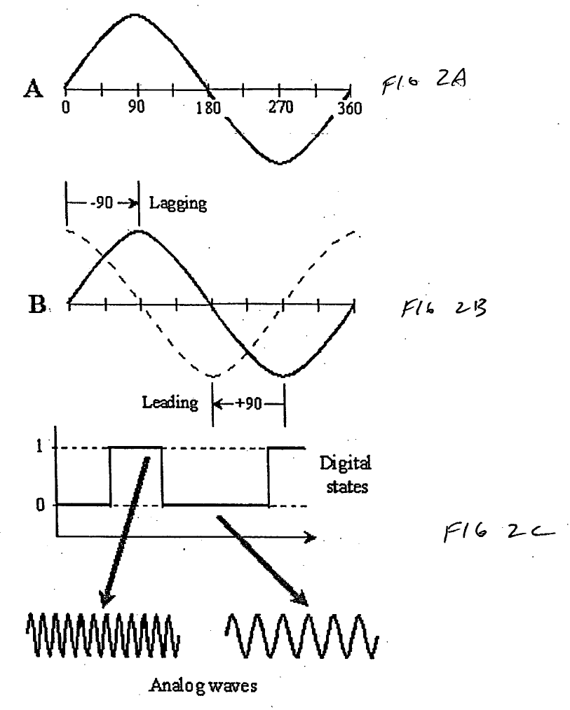

In one embodiment, the wireless communication link comprises a phase shifted signal. In electronic signaling, the phase of a signal represents a position of the signal at a specific point in time. FIG. 2A illustrates a complete cycle of an exemplary waveform, including 360 degrees of phase. A phase difference, also referred to as a phase angle, is the phase difference between two or more waves. The phase difference of two waves is typically between −180 and +180. A leading phase refers to a wave that occurs “ahead” of another wave of the same frequency while a lagging phase refers to a wave that occurs “behind” another wave of the same frequency. When two signals differ in phase by −90 or +90 degrees, they are said to be in phase quadrature. FIG. 2B illustrates an exemplary waves that are in phase quadrature. Because the wave depicted by the dashed line leads the wave represented by the solid line by 90 degrees, the waves are in phase quadrature. When two waves differ in phase by 180 degrees (−180 is technically the same as +180), the waves are said to be in phase opposition.

Phase modulation (PM) is a method of impressing data onto an alternating-current (AC) waveform by varying the instantaneous phase of the wave. This scheme can be used with analog or digital data. In analog PM, for example, the phase of the AC signal wave, also called the carrier, varies in a continuous manner. Thus, there are infinitely many possible carrier phase states. When the instantaneous data input waveform has positive polarity, the carrier phase shifts in one direction; when the instantaneous data input waveform has negative polarity, the carrier phase shifts in the opposite direction. At every instant in time, the extent of carrier-phase shift (the phase angle) is directly proportional to the extent to which the signal amplitude is positive or negative.

In digital PM, the carrier phase shifts abruptly, rather than continuously back and forth. The number of possible carrier phase states is usually a power of 2. If there are only two possible phase states, the mode is called biphase modulation. In more complex modes, there can be four, eight, or more different phase states. Each phase angle (that is, each shift from one phase state to another) represents a specific digital input data state.

Phase modulation is similar in practice to frequency modulation (FM). When the instantaneous phase of a carrier is varied, the instantaneous frequency changes as well. The converse also holds: When the instantaneous frequency is varied, the instantaneous phase changes. But PM and FM are not exactly equivalent, especially in analog applications. When an FM receiver is used to demodulate a PM signal, or when an FM signal is intercepted by a receiver designed for PM, the audio is distorted. This is because the relationship between phase and frequency variations is not linear; that is, phase and frequency do not vary in direct proportion.

Phase-shift keying (PSK) is another modulation method that may be used for transmitting and receiving digital signals. There are several schemes that can be used to accomplish PSK. The simplest method uses only two signal phases: 0 degrees and 180 degrees. The digital signal is broken up timewise into individual bits (binary digits). The state of each bit is determined according to the state of the preceding bit. If the phase of the wave does not change, then the signal state stays the same (low or high). If the phase of the wave changes by 180 degrees—that is, if the phase reverses—then the signal state changes (from low to high, or from high to low). Because there are two possible wave phases, this form of PSK is sometimes called biphase modulation.

More complex forms of PSK employ four or eight wave phases. This allows binary data to be transmitted at a faster rate per phase change than is possible with biphase modulation. In four-phase modulation, the possible phase angles are 0, +90, −90, and 180 degrees; each phase shift can represent two signal elements. In eight-phase modulation, the possible phase angles are 0, +45, −45, +90, −90, +135, −135, and 180 degrees; each phase shift can represent four signal elements.

Frequency-shift keying (FSK) is another modulation method that may be used to modulate transmitted digital signals. FIG. 2C illustrates a digital signal and exemplary portions of an FSK signal that may be used to represent the digital signal. In one embodiment, the two binary states, logic 0 (low) and 1 (high), are each represented by an analog waveform. Logic 0 is represented by a wave at a specific frequency, and logic 1 is represented by a wave at a different frequency. A modem converts the binary data from a computer to FSK for transmission over telephone lines, cables, optical fiber, or wireless media. The modem also converts incoming FSK signals to digital low and high states, which the computer can “understand.”

The systems and methods of wireless communication described herein may implement any of the above described modulation schemes, any other existing or later developed modulation schemes, or any combination of modulation schemes. For ease of description, the following drawings refer to phase modulation. However, it is expressly contemplated that phase modulation may be replaced by any other type of modulation. Thus, any reference to phase modulation should be interpreted to cover other types of modulation also.

In the embodiment of FIG. 1, the receiving module 110 comprises a receiver 112 and an antenna 114. The antenna 114 comprises any suitable antenna for receiving the wireless communication 115. In one embodiment, the antenna 114 includes a wide band filter. The receiver 112 is coupled to the antenna 114 and includes circuitry to extract the data signal encoded on the wireless communication 115. In one embodiment, the receiver comprises a narrow band filter, such as a notch filter and an analog-to-digital converter that converts the received RF signal to a digital signal. In one embodiment, the digital representation of the received wireless communication is transmitted to one or more digital signal processors that decode the data that is encoded on the transmitted signal. Advantageously, the digital signal processor (DSP) is configured to decode data that is encoded on each wave of the received wireless communication, without the need for mixing the received signal and creating a lower frequency IF signal.

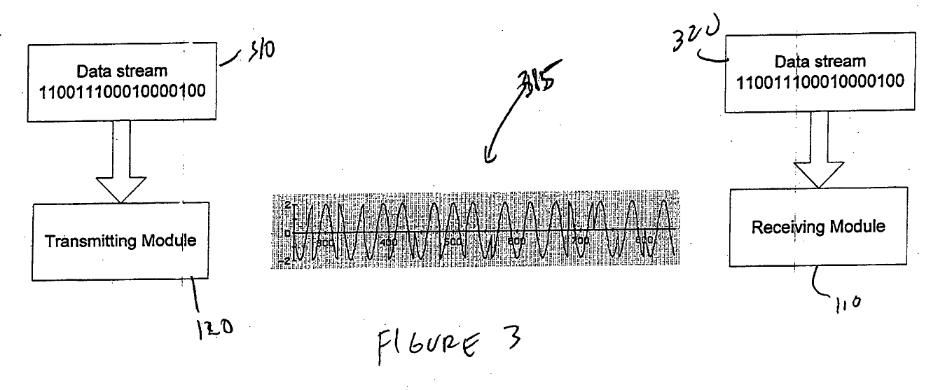

FIG. 3 is a block diagram illustrating the transmitting module 120 and receiving module 110 and an exemplary portion of a transmitted wireless communication 315. In the embodiment of FIG. 3, the wireless communication 315 comprises a QPSK modulated carrier wave, where the QPSK modulation has been applied to the carrier wave in accordance to a received data stream 310. Thus, each waveform of the wireless communication 315 comprises one or more encoded bit(s) of the data stream 310. As noted above and described in further detail below, the receiving module 110 advantageously comprises one or more DSPs that are configured to detect phase changes in the received signal so that a bit of data may be detected from each waveform.

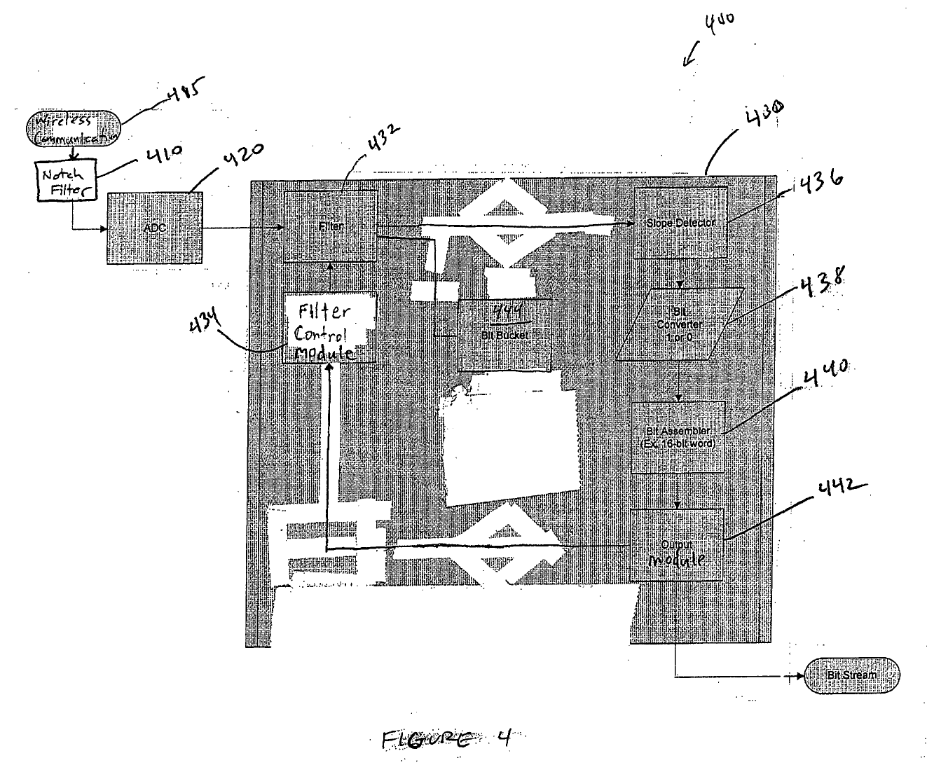

FIG. 4 is a flowchart diagram of an exemplary receiving module 400 coupled to receive a digital representation of a received wireless communication. In the embodiment of FIG. 4, a wireless communication 415, such as the QPSK modulated wireless communication 315, is received at an antenna and passed through a notch filter 410. The notch filter, also referred to as a band-stop filter, a narrow band-pass filter, or T-notch filter, comprises an electronic filter that passes only a predetermined range of frequencies. In certain embodiments, notch filters pass wave frequencies between a low and high frequency, where the high frequency and the low frequency are less than 1 to 2 decades apart (that is, the high frequency is less than 10 to 20 times the low frequency).

The output of the notch filter 410 is transmitted to an analog-to-digital converter (ADC) 420. After being digitized through the ADC 420, the digitized signal is transmitted to a DSP 430. In general, a DSP is a specialized microprocessor designed specifically for digital signal processing, generally in real-time. DSPs can also be used to perform general-purpose computation. DSPs may have an instruction set (ISA) optimized for the task of rapid signal processing, often using the techniques such as Multiply-accumulate (MAC) operations (good for all kinds of matrix operations), deep pipelining, the ability to act as a direct memory access device for the host environment, Saturation arithmetic, and separate program and data memories (Harvard architecture). DSPs may be dedicated integrated circuits or DSP functionality may be realized using Field Programmable Gate Array (FPGA) chips, for example. In one embodiment, the DSP 430 comprises an ultra-high performance, static superscalar processor optimized for large signal processing tasks and communications infrastructure.

In one embodiment, the DSP 430 has a 2 ns Instruction Cycle Rate, an internal 24 MB DRAM, and four independent 128-bit wide internal data buses, each connecting to six 4 MB memory banks in order to enable quad word data instruction and I/O access and providing 28 Gbps of internal memory bandwidth. In one embodiment, the DSP 430 is capable of calculating 4 billion 40-bit MACs or 1 billion 80 bit MACs per second.

The exemplary DSP 430 comprises a filter 432, a filter control module 434, a slope detector 436, a bit converter 438, a bit assembler 440, and an output module 442. In general, these components determine if a received signal is intended for decoding by the DSP 430, detect phase changes in the received signal, and convert the detected phase changes to a digital bit stream. Because the DSP is configured to decode data from every waveform of the wireless communication 415, the receiver 400 does not need to create an IF signal at a lower frequency that the received wireless communication 415. The DSP 430 is exemplary and should not be interpreted as limiting the possible implementations of a signal processor in a receiving module.

In the embodiment of FIG. 4, the filter 432 comprises a select band filter configured to pass a very narrow and limited number of frequencies. In one embodiment, the filter 432 passes such a narrow frequency of signal that any signal that passes through the filter 432 is considered intended for the particular DSP 430. Thus, the filter 432 may be used as a signal detector. In the embodiment of FIG. 4, the pass frequency of the filter 432 is controlled through a filter control module 434 that may include an oscillator. The filter control module 434 may also include circuitry that adjusts the pass frequency of the filter 432 based on a frequency hopping algorithm, such as spread spectrum. In one embodiment, the filtered signal is stored in a bit bucket 444, such as a FIFO cache, for a predetermined time before being discarded.

In one embodiment, the filter 432 comprises a means for detecting a single frequency from a narrow (or wide) band of frequencies being received. As noted above, a narrow band of frequencies is sent from the notch filter 410 to the DSP 430. The DSP 430 may be further configured to detect and demodulate the intelligence off a single frequency included in the received narrow band signal.

In one embodiment, the filter 432 comprises an EEPROM, or other memory device, stores a bit pattern representative of the frequency being selected. When the system powers up, the bit pattern stored in the EEPROM is accessed and the DSP 430 analyzes the incoming narrow band signal against this bit pattern. When a match occurs, a signal detect is recognized and the matching signal frequency is passed through the filter 432.

In another embodiment, the filter 432 comprises a Phase Lock Loop (PLL). In this embodiment, when a signal matching a particular frequency is received from the narrow band, a bit is set in a DSP 430 register. The DSP 430 subsequently locks onto this signal, and begins the demodulation process.

In another embodiment, an oscillator generates a waveform having the frequency of the signal to be decoded, and transmits the waveform to a first channel of the DSP. The output of the notch filter is transmitted to a second channel of the DSP. When a match occurs between the first and second channels, the set frequency is detected, thus beginning the DSP's demodulation process.

The circuitry used in the select band filter 432 may depend on the hysteretics of the DSP microchip chosen for the design, the quality of the notch filter, and the specific requirements for the transceiver.

The filtered signal from filter 432 is then transmitted to the slope detector 436, which detects phase changes in the signal and indicates the phase changes to the bit converter 438. The bit converter 438 converts the phase changes indicated by the slope detector 436 into bits of data. The process performed by slope detector 436 and bit converter 438 is essentially the reverse of the modulation process used to encode data on the carrier signal at the receiver. Thus, if the modulation application to a carrier signal before transmitting is PSK, the slope detector 436 and bit converter 438 will be configured to PSK decode the filtered signal from filter 432.

In the embodiment of FIG. 4, the bits from bit converter 436 are transmitted to a bit assembler 440 that assembles consecutive bits of data into bytes, words, double-words, or other group of binary data. The assembled bits are then transmitted to an output module 442 that prepares the data for transmission on a transmission medium, such as Ethernet, fiber-optic cabling, or computer bus.

In one embodiment, certain groups of bits, such as data words, from the bit assembler 440 include a preamble indicative of a frequency hop. In this embodiment, the filter control module 434 receives at least a portion of the bit stream from the output module 442 and is configured to detect whether a preamble is included in the received data. If a preamble is detected, the preamble is decoded to determine an appropriate frequency and this information is sent to the filter control module 434 for use in setting a frequency of the filter 432.

This receiver design also has the ability to weight received RF signals, thereby increasing the number of bits received per waveform. For example, a protocol can be used such that if the received RF is in a particular binary pattern, a mathematical computation is then executed complimenting the resulting transmitted data (e.g. The Method of Compliments). The method of complements is perhaps most famous in its binary variations (called one's complement and two's complement) because those are the methods that most computers use to subtract. By using the Two's Complement method, we are able to obtain larger number sets than could be conventionally obtained with conventional RF design (e.g. negative numbers).

One or more bits per wavelength may also be encoded on a carrier signal using variations of PSK modulation. For example, the computer bus needs to transmit bits over the network. Using BPSK, a binary 0 may be represented by a 0 phase shift, while a binary 1 may be represented by a 180 phase shift. The transmitter circuitry would then convert the data stream to a corresponding phase shifted RF, and the receiver would re-convert the RF back to binary data. Using QPSK, for example, two binary data bits can be converted to a single phase shift. For example:
0°=00
−45°=11
+45°=01
+180°=10

In this example, the bandwidth of the transmitted RF signal is effectively doubled and two bits of data may be encoded per waveform without increasing the carrier frequency. As mentioned throughout this document, other multiplexing modulation schemes can be applied in order to allow more than one bit per waveform to be transmitted and received per RF wavelength. In one embodiment, using QPSK as described above, a 900 MHz frequency carrier signal may be capable of transmitting data at 1.8 Gbps. In another embodiment using DPSK, throughput of 2.7 Gbps may be obtained without increasing the carrier frequency of 900 MHz nor applying the two's compliment method. Thus, the technology is scalable with the use of various existing or later developed modulation schemes.

In one embodiment, the DSP 400 may be replaced with discrete circuitry, one or more Field Programmable Gate Arrays (FPGAs), Application Specific Integrated Circuit (ASIC), and/or one or more Digital Signal Processors (DSP). The choice of circuitry, and whether it would be placed in an array or individual component may depend on the frequency and bandwidth objectives of the design.

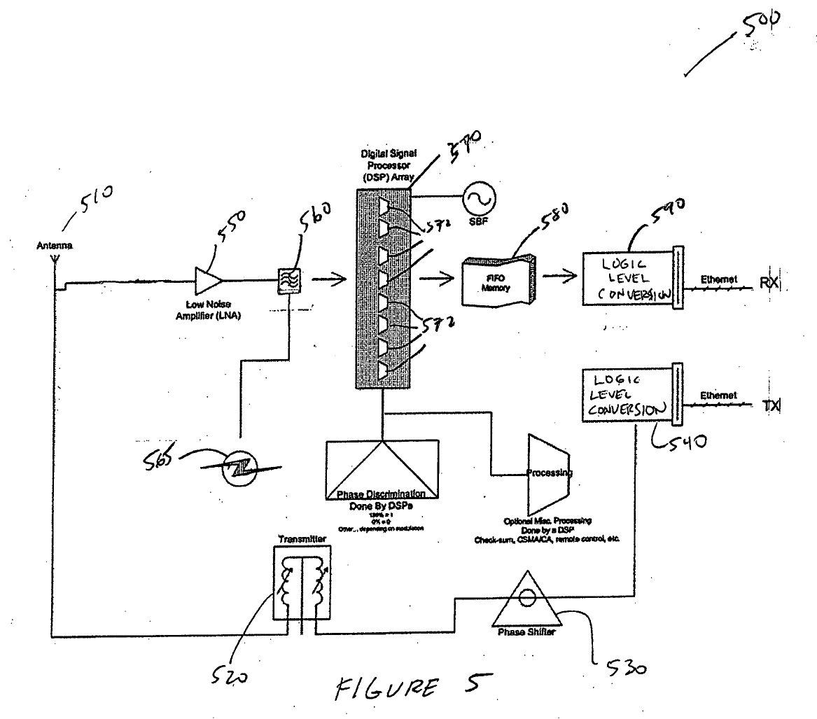

FIG. 5 is a block diagram of an exemplary transceiver that includes both a receiving module and a transmitting module. The transmitting module of FIG. 5 comprises an antenna 510, a transmitter 520, a phase shifter 530, and a logic level conversion module 540. The receiving module of FIG. 5 comprises the antenna 510, a low noise amplifier 550, a notch filter 560, a voltage controlled oscillator 570, an array of DSPs 572, a FIFO memory 580, and a logic level conversion module 590. The combination of components illustrated in FIG. 5 is exemplary and is not intended to limit the types and configurations of alternative components. Fewer or more components may be used to achieve similar functionality.

In the embodiment of FIG. 5, a data stream for wireless transmission is received by the logic level conversion module 540 via an Ethernet connection to a computing device. In one embodiment the data stream is transmitted use PECL logic signal levels and the components of the transmitting module 120 operates using TTL logic levels. Accordingly, in one embodiment the logic level conversion module 540 converts the incoming PECL datastream to a TTL datastream. In other embodiments, the logic level conversion module 540 may perform different signal level conversions, or the logic level conversion module 540 may not be necessary.

Once the incoming data stream has been converted to an appropriate logic level, such as TTL levels, for example, the signal is received by a phase shifter 530. The phase shifter 530 encodes the incoming data stream onto a carrier signal, such as a sinewave. As noted above, the carrier signal may be modulated using any currently or later developed modulation schemes, such as PSK or FSK, for example. In one embodiment, the carrier signal has a frequency of about 900 MHz. In another embodiment, the carrier signal has a frequency of about 2.4 GHz or 5.8 GHz. In one embodiment, the carrier signal is 915.225 MHz. Any other frequency of carrier signal may be used in connection with the systems and methods described herein. In the embodiments described herein, the carrier signal is modified using a phase modulation such that each waveform carries at least one bit of data.

In the embodiment of FIG. 5, the transmitter 520 receives the encoded carrier signal and performs various filtering and amplifications of the signal prior to transmitting to the antenna 510. The antenna 510 may comprise one or more antennas of various types. For example, in one embodiment the antenna 510 comprises a microstrip antenna, while in another embodiment the antenna 510 comprises a feedhorn antenna, and in other embodiments the antenna 510 comprises a combination of one or more microstrip and feedhorn and in certain embodiments, a microstrip antenna is used for transmission and reception of carrier signals having a frequency of about 5.8 GHz or less and a feedhorn antenna is used for transmission and reception of carrier signals having a frequency of greater than 5.8 GHz, including carrier frequencies of 10 GHz or above.

Moving to the receiving module portion of the transceiver 500, a RF signal is initially received on the antenna 510. As discussed above, the antenna 510 may comprise one or more of various types of one or more antennas. The received RF signal is then transmitted to a low noise amplifier 550 configured to increase and amplitude of the received signal without significantly increasing a signal-to-noise ratio of the signal. The signal is then passed through a notch filter 560 that is configured to pass only a narrow range of signal frequencies. In one embodiment, a pass frequency of the notch filter 560 is adjusted by a voltage controlled oscillator (VCO) 565. In this embodiment, the VCO 565 is not used for frequency division of the signal, but only to maintain and/or adjust a pass frequency of the notch filter 560. In one embodiment, the VCO 565 has variable frequency tuning capabilities, allowing remote adjustment. In one embodiment, the notch filter 560 comprises multiple filters. Because the notch filter is set to pass only a narrow frequency band, the DSP array 570 will process only that narrow band of frequencies, rather than the “wide band” passed from the antenna 510. It is recommended the VCO in this configuration have variable frequency capabilities, allowing remote administration, tuning, etc. However, this requirement is not a necessity.

After the incoming signal has been properly filtered, the signal is transmitted to an array 570 of DSPs 572. In certain embodiments, the frequency of the incoming carrier signal is too high to allow a single DSP 572 to accurately decode the intelligence on each waveform of the signal. For example, a high frequency, such as 10 GHz or higher, signal may require multiple DSPs to decode the signal. Depending on the particular communication system, various numbers of DSPs 572 may be included in the receiving module. For example, the number of DSPs 572 in the array 570 may be increased or decreased depending on the carrier frequency and on the modulation/multiplexing schemes employed, or other criteria. In the embodiment of FIG. 5, the array 570 comprises eight DSPs 572.

In one embodiment, the DSPs 572 comprise on-chip distributed bus architecture logic that provides glueless connections for systems containing up to eight or more DSPs 572 and a host processor. In one embodiment, the processing power of the DSP Array 570 is roughly six times more than needed to provide 5 Gbps throughput and 10 Gbps throughput in full duplex mode. In one embodiment, trunking software or a simple 2-bit multiplexing scheme, for example, may be implemented in order to increase full duplex throughput to 20 Gbps or more.

In one embodiment, one or more of a DSPs 572 comprises a select band filter that attenuates frequencies outside the frequency expected by the array 570. For example, if the array 570 is configured to receive wireless communications at 915.225 MHz, a select band filter may be configured to attenuate frequencies less than 915.220 MHz and the greater than 915.230 MHz. In this way, the select band filter allows only the signals intended for the receiving module to be decoded.

In one embodiment, the array 570 is arranged so that consecutive waveforms of the incoming signal are routed to the DSPs 572 in an alternating round robin fashion. Accordingly, with an array of eight DSPs 572, each of the DSPs 572 receives only in ⅛ of the received waveforms. For example, as a first waveform is received, it is sent to DSP₁ (the first DSP in the array) that processes that waveform. The next waveform is sent to DSP₂ for processing, the third waveform is sent to DSP₃, and so forth. In one embodiment, the array 570 comprises circuitry that monitors timing of the round robin distribution of incoming waveforms to ensure that as a waveform enters the last DSPₙ in the array, DSP₁ is finished processing its previous waveform, and waiting to begin a new cycle in the array. In other embodiments, the DSPs 572 in the array 570 may be configured to operate together in various manners.

The number of DSPs 572 in the array 570 may be increased or decreased depending on frequency used, and on the modulation/multiplexing schemes employed, or other criteria. Furthermore, as more powerful DSPs become available in the market, the number in the array may also decline.

In advantageous embodiments, the DSP array 570 detects predefined phase shifts and converts the analog signal to digital information, such as binary data bits. For example, a 180° phase shift may represent a change in state. Accordingly, the DSP array 570 recognizes this change in phase as a change in logic levels, and alternates eight current states of the output. When the next waveform arrives, if there is no change in phase, the array 570 maintained the digital output in its current state, so that the current bit is the same as the previous bit. As illustrated in FIG. 5, a register, such as a FIFO memory 580 receives the digital output from the array 570 and temporarily stores the data stream for transmission. Advantageously, the array 570 converts the incoming communication signal to digital intelligence without the need for frequency reduction of the signal.

In one embodiment, the modulation scheme employed to encode data on the carrier signal employs a pseudo random frequency hopping protocol. In one embodiment, the pseudo random frequency hopping protocol includes hops between narrow channels, such as less than 1 MHz, and frequency changes in milliseconds. With the addition of a frequency hopping protocol, the occurrence of multipath propagation may be reduced.

In one embodiment, a specialized modulation technique specifically designed for use with the DSP Array 570 may be used. One such specialized modulation technique is Reciprocal Junctive Spread Spectrum/Internet Protocol (RJSS/IP). In one embodiment, RJSS modulation uses a frequency hopping algorithm, whose seed number can be user defined. In systems using RJSS modulation, the systems may operate right next to each other at similar frequencies using two different frequency hopping schemes. In RJSS, the reciprocal of the MAC Address from the transmitter's network interface card is used as the seed number for the algorithm used in Spread Spectrum. Thus, no two hopping algorithms will ever be the same.

After decoding the logic on the received modulated carrier signal, a digital data stream is transmitted to the FIFO memory 580 and then to the logic level conversion module 590. The logic level conversion module 590 may convert the digital data bits from TTL to PECL levels, for example, for transmission on an Ethernet network.

In certain embodiments, the transceiver 500 and/or receiving module 110 decode a data bit from each wavelength. Thus, if a carrier signal has a frequency of 5.8 GHz and a desired throughput of 2 Gbps is required, the bandwidth provided by the systems described herein may be reduced by a factor of more than two while still achieving the desired throughput. In one embodiment, a new modulation protocol provides a desired throughput when using a higher bandwidth communication. In one embodiment, this modulation protocol is referred to as miniplexing, where miniplexing comprises placement of a single bit of intelligence on multiple waveforms. Thus, miniplexing slows down the receiver throughput by modulating two or more carrier signals with identical bits of information. For example, the system may decode a single digital bit (1 or 0) in response to receiving 10 waveforms with the same encode data bit.

In one embodiment, miniplexing is implemented according to the formula: Transmission Frequency (TF)÷Desired Throughput (DT)=Miniplex Denominator (MD). In one embodiment, to avoid modulation of a fractional waveform, the Miniplex Denominator may be rounded to the nearest whole signal. For example, if the TF is 5.8 GHz, and the DT is 2 Gbps, then MD is 2.9. However, MD should be rounded to either 2 or 3. If MD is rounded to 3, when 3 modulated signals are received with the same bits, a single digital bit is registered. As those of skill in the art will recognize, when MD is rounded up, the theoretical throughput will be less then the Desired Throughput (DT). Likewise, if MD is rounded down, the theoretical throughput will be greater than the DT.

In certain embodiments, the communication systems described herein utilizes bandwidth management software that reduces individual network segments or clients from hogging the bandwidth. Although important in virtually any networked application, the requirement for Bandwidth Management is most notably needed in a LAN application. In one embodiment, the bandwidth management includes dynamic load balancing functionality. Dynamic load balancing allows users to allocate a user-defined percentage (1%-99%) of the network load to any network segment or individual client in order to control bandwidth consumed by individual connections.

In certain embodiments, the systems and methods described herein increase fault tolerance by implementing two or more parallel wireless systems. In these embodiments, if an antenna, cable, radio front-end, or other hardware fault is detected (e.g. interrupts), traffic is automatically routed to the redundant wireless channel(s).

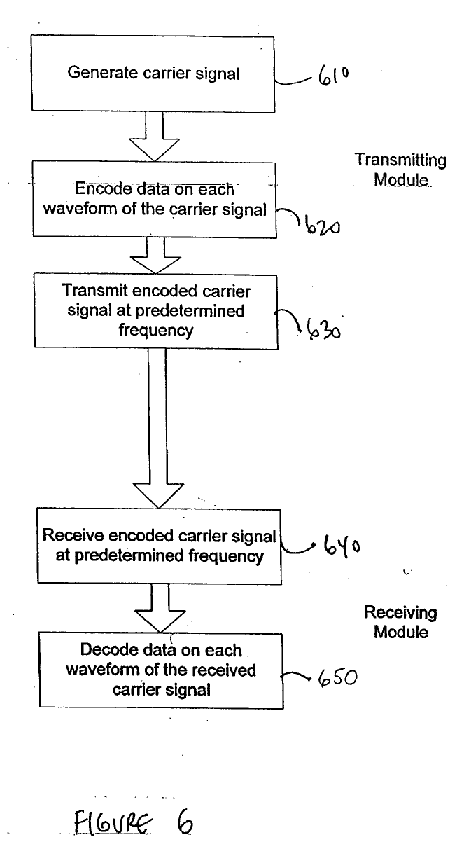

FIG. 6 is a flowchart illustrating an exemplary process of transmitting and receiving digital data using the systems and methods described herein. In a block 610, a carrier signal is generated. As noted above, the carrier signal is advantageously modulated so that each waveform contains at least one bit of intelligence. The carrier signal may be generated by a signal generator or by any other suitable means.

In a block 620, data received from a computing device is encoded on the carrier signal. In an advantageous embodiment, a bit of data is encoded on each waveform. In one embodiment, the data is encoded on the carrier signal using phase modulation, such as that illustrated in FIG. 3, for example.

Moving to a block 630, the carrier signal is transmitted at a predetermined frequency. In one embodiment, the predetermined frequency is in the range of about 850-950 MHz, 2.3-2.5 GHz, or 5.5-6.0 GHz, for example. In one embodiment, the predetermined frequency is about 915.225 MHz. The predetermined frequency may be any other frequency suitable for transmission. Advantageously, the data modulated on the carrier signal is directly proportional to the frequency of the carrier signal. For example, if the frequency of the carrier signal is 915 MHz, the rate of data transmission is about 915 Mbps due to the application of a bit of data on each waveform of the carrier signal.

Continuing to a block 640, a receiving module receives the carrier signal at the predetermined frequency. As described above, various processes may be performed in order to isolate the predetermined frequency signal from other radio frequency signals that may be received by the receiving model.

At a block 650, data on each waveform of the received carrier signal is decoded. Advantageously, the receiving module comprises one or more DSPs configured to decode data on the received carrier signal at the frequency at which the carrier signal is received. Accordingly, the receiving module does not need to perform any mixing of the received carrier signal in order to reduce a frequency of the carrier signal.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A wireless receiver for receiving data at a rate of more than 300 bits per second on a carrier signal having a frequency of more than about 300 MHz, the wireless receiver comprising:
an antenna that receives a transmitted RF signal;
a filter coupled to the antenna for passing only a predetermined frequency range of the RF signal, referred to as a filtered data signal, the filtered data signal comprising a carrier signal that is phase modulated to represent data, wherein each waveform of the filtered data signal contains at least one bit of data;
an analog to digital converter for converting the filtered data signal to a digital representation of the filtered data signal, referred to as a digital data signal; and
a digital signal processor coupled to the analog to digital converter and comprising:
a select band filter for passing only a predetermined frequency of the digital data: signal received from the analog to digital converter;
a filter control module coupled to the select band filter for setting the predetermined frequency that is passed by the select band filter;
a detector for detecting phase changes in the digital data signal;
a bit converter coupled to the detector for converting the phase changes detected by the slope detector to corresponding binary data bits;
a bit assembler for receiving the binary data bits from the bit converter and assembling the binary data bits into groups of data bits, wherein each group of data bits comprises a predetermined number of data bits;
an output module for receiving the groups of data bits, converting a logic level of data bits in the groups of data bits for transmission on a wired communication medium, and transmitting the logic level converted groups of data bits on the wired communication medium;
wherein the digital signal processor detects outputs data from each waveform of the filtered data signal without mixing the filtered data signal with another signal, wherein the digital signal processor outputs a binary data stream at a rate of at least one bit per waveform of the received radio frequency data signal.

2. The wireless receiver of claim 1, wherein the detector comprises a slope detector.

3. The wireless receiver of claim 1, wherein the predetermined frequency is in the range of about 902 MHz to 928 MHz.

4. The wireless receiver of claim 1, wherein the predetermined frequency is 915.225 MHz.

5. The wireless receiver of claim 1, wherein the filter control module comprises a voltage controlled oscillator.

6. The wireless receiver of claim 1, wherein the phase modulation comprises QPSK modulation.

7. The wireless receiver of claim 6, wherein two bits of data are encoded on each waveform of the received radio frequency data signal.

8. The wireless receiver of claim 7, wherein the bit converter outputs:
digital bits 00 in response to receiving a 0° phase shift from the detector;
digital bits 11 in response to receiving a −45° phase shift from the detector;
digital bits 01 in response to receiving a +45° phase shift from the detector; and
digital bits 10 in response to receiving a +180° phase shift from the detector;

9. The wireless receiver of claim 1, wherein the digital signal processor comprises a field programmable gate array.

10. A no-conversion radio for decoding data encoded on individual waveforms of a received radio frequency signal, wherein the radio frequency signal comprises at least one bit of data encoded on each waveform, the no-conversion radio comprising:
a receiver for receiving a radio signal;
a filter for attenuating portions of the radio signal outside a predetermined frequency range; and
one or more digital signal processors for selecting the predetermined frequency of the radio signal and decoding data encoded on each waveform of the radio frequency signal so that data is decoded at a rate of about one bit per waveform, wherein the one or more digital signal processors operate on the radio signal at the predetermined frequency.

11. The no-conversion radio of claim 10, wherein the one or more digital signal processors comprises an array to alternatively decode waveforms of the radio signal.

12. The no-conversion radio of claim 10, wherein the selected frequency of radio signal is transmitted and received within one of a Local Area Networks, a Metropolitan Area Networks, and a Wide Area Networks.

13. The no-conversion radio of claim 10, wherein the selected frequency of radio signal is encoded with one or more of: CSMA/CA, CSMA/CD, Checksum, CRC, ERC, synchronization, frequency hopping, forward error correction, and a spread spectrum algorithm.

14. The no-conversion radio of claim 10, wherein a frequency range that is passed by the filter is set by a variable frequency voltage controlled oscillator (VCO).

15. The no-conversion radio of claim 10, wherein the filter comprises a notch filter.

16. The no-conversion radio of claim 10, further comprises an output module for receiving the decoded data from the one or more digital signal processors and converting the decoded data for transmission on a communication medium.

17. The no-conversion radio of claim 16, wherein the output module outputs a single bit of data on the communication medium in response to receiving a predetermined number of equal bits from the one or more digital signal processors.

18. The no-conversion radio of claim 10, further comprising a failover controller.

19. The no-conversion radio of claim 10, wherein the selected signal comprises one or more data signals trunked by a transmitting device.

20. The no-conversion radio of claim 10, further comprising a dynamic load balancing controller.

21. The no-conversion radio of claim 10, wherein the data decoded by the one or more digital signal processors is encrypted.

22. A method of receiving radio signals containing modulated data on a carrier signal having a predetermined frequency of more than about 300 MHz, wherein each waveform of the carrier signal is modulated to encode at least one bit of data, the method comprising:
receiving a radio signal;
attenuating portions of the radio signal outside the predetermined frequency range;
selecting the predetermined frequency of the radio signal;
amplifying the predetermined frequency of the radio signal; and
decoding the at least one bit of data encoded on each waveform of the amplified radio signal so that data is decoded at a rate of at least 300 Mbps.

23. The method of claim 22, wherein the step of selecting comprises:
generating a waveform having the predetermined frequency;
comparing the generated waveform with the received radio signal; and
selecting the received radio signal when the generated waveform matches the received radio signal.

24. The method of claim 22, wherein the step of selecting comprises:
receiving a radio signal matching a particular frequency using a phase lock loop; and
locking onto the radio signal matching the particular frequency.

25. The method of claim 22, wherein the step of selecting comprising:
storing a predetermined bit pattern in a memory;
comparing a received radio signal with the predetermined bit pattern; and
selecting the received radio signal when the received radio signal matches the predetermined bit pattern.

26. The method of claim 22, wherein the predetermined frequency is about 900 MHz and the rate of receiving data is about 900 Mbps.

27. The method of claim 22, wherein the predetermined frequency is about 2.8 GHz and the rate of receiving data is about 2.8 Gbps.

28. The method of claim 22, wherein the predetermined frequency is about 5.6 GHz and the rate of receiving data is about 5.6 Gbps.

29. A method of detecting a predetermined frequency of radio signal, the method comprising:
storing a bit pattern in a memory;
receiving a radio signal comprising multiple radio frequencies including a signal having a predetermined frequency intended for decoding;
decoding data encoded on a the received radio signal;
comparing the decoded data against the bit pattern stored in memory; and
determining that the signal having the predetermined frequency is being received when the decoded data matches the bit pattern stored in memory.

30. The method of claim 29, wherein the bit pattern comprises one or more bits of data.

31. A wireless data transmitter configured to transmit data encoded as phase modulations in an RF carrier signal, the transmitter comprising:
a data input port;
a processor coupled to the data input port, the processor receiving a digital data stream comprising a plurality of data bits via the data input port and encoding the data stream onto a carrier signal having a predetermined frequency, wherein each waveform of the carrier signal is modulated to encode at least one data bit of the data stream; and
a transmission module for transmitting the encoded carrier signal at a predetermined frequency.

32. The wireless data transmitter of claim 31, wherein the data stream is encoded onto the carrier signal using phase modulation.

33. The wireless data transmitter of claim 31, wherein the data stream is encoded onto the carrier signal using Quad Phase Shift Keying modulation.

34. A wireless digital data device configured to receive data at a rate of more than one gigabit per second, the device comprising:
an antenna assembly configured to receive a radio frequency data signal;
a low noise amplifier electrically coupled to the antenna for amplifying the data signal;
a notch filter coupled to the low noise amplifier for passing only a predetermined frequency range of the radio frequency data signal, referred to as a filtered data signal; and
one or more Digital Signal Processors (DSPs) each configured to detect a single frequency of the filtered data signal and extrapolate data from each waveform of the filtered data signal without mixing the data signal with another signal, wherein the one or more DSP's output a binary data stream at a rate of at least one bit per waveform of the received radio frequency data signal.

35. The wireless digital data device of claim 31, wherein the one or more DSPs process sequential waves of the filtered data signal in a round robin fashion.

36. The wireless digital data device of claim 31, wherein the antenna assembly comprises a reflector, a feedhorn, one or more feed lines, and a control circuit.
